(19) United States
(12) Patent Application Publication
(10) Pub. No.: US 2004/0163553 A1
(43) Pub. Date: Aug. 26, 2004

(54) Frame preparation for screen printing

(76) Inventors: Tom Bock, Kansas City, KS (US); Larry Olson, Kansas City, KS (US)

Correspondence Address: Reed Smith, 29th Floor, 599 Lexington Avenue, New York, NY, 10022, US

(21) Appl. No.: 10/478,712

(22) PCT Filed: May 10, 2002
(86) PCT No.: PCT/GB02/02165

(30) Foreign Application Priority Data
Oct. 19, 2001 (GB) 0125193.3

(51) Int. Cl. B41M 1/12

(52) U.S. Cl. 101/129

(57) ABSTRACT

The present invention provides a process for regenerating used screen printing frames contaminated with residues from the screen printing process comprising heating the used frame at a sufficient temperature and for sufficient time to thermally degrade the residues. The process is used particularly for removing mesh, adhesive, printing ink and/or residual paint from the frame.

This invention relates to frame preparation for screen printing and in particular to a process for regenerating used frames.

Screen printing is a process in which ink is forced through open areas of a stencil onto a substrate using a squeegee. The stencil is supported on a taught mesh, usually of nylon or polyester, attached to a rigid frame, usually of aluminium or steel.

Screen printers and screen shops have to prepare frames so that new mesh can be attached to the frames. This preparation includes removing the mesh, adhesive, and printing ink from the frame. A new mesh may then be applied to the suitably prepared frame. The frame must have a profile such that new mesh may be attached thereto.

Screen printers and screen shops commonly remove the mesh by peeling it off by hand. When the mesh has been removed, the adhesive is still left on the surface of the frame. The adhesive is removed by grinding, blasting or by stripping with chemicals.

Grinding the frames eventually removes the adhesive but is labour intensive and will deteriorate the frames over time with repeated use.

The adhesive can also be removed from the frames by blasting the frames using a number of different media (e.g. sand blasting). However, blasting will also deteriorate the frames when it is done repeatedly and there will come a point when the frames will have to be replaced with new frames. Furthermore, both grinding and blasting create airborne particles. These airborne particles cannot be allowed to contaminate the finished product of the printing process and hence the grinding or blasting facility has to be maintained in an isolated, air-cleaned room and ideally at another site. When blasting, large storage bins are also required to hold the blasting media.

The adhesive can also be removed from the frames by soaking the frames in a chemical solution. The chemicals used to remove the adhesives typically take 30 minutes or longer to loosen up the adhesives and even then the adhesive may have to be removed by scraping. These chemicals are often very hazardous and carcinogenic in nature. These chemicals can be very expensive and difficult to handle and must be disposed of according to stringent environmental regulations.

After removal of the adhesive, further chemicals are often used to remove the printing ink which remains on the frames after the printing process. These chemicals also possess many of the disadvantages mentioned above.

In order to obtain a proper profile on the treated frames so that new mesh can be attached to them, the frames may require an additional process, i.e. grinding or blasting. This is especially true for frames which have had the adhesive removed by chemical means.

Thus, there remains a need for a single (or one step) process which enables the removal of mesh, adhesives and inks from used frames which avoids the disadvantages associated with the known techniques and prepares the frame surface for reuse.

Accordingly, the present invention provides a process for regenerating used screen printing frames contaminated with residues from the screen printing process comprising heating the used frame at a sufficient temperature and for sufficient time to thermally degrade the residues.

Preferably the residue is one or more of a mesh, an adhesive, a printing ink, or residual paint.

Preferably the heating is carried out at from 150° C. to below the distortion point of the frame. More preferably the frame consists substantially of aluminium and heating is carried out at 150 to 425° C. or the frame consists substantially of steel and heating is carried out at 150 to 650° C. More preferably the heating is carried out at 315 to 425° C. Most preferably the heating is carried out at 370° C.

Preferably, heating is carried out for 30 min to 8 hours, particularly preferably for 1 to 2 hours.

Preferably the heating is carried out until the residues are degraded to a dry ash.

Preferably the process further comprises the application of a powder coating to the frame, particularly preferably the powder coating is an epoxy or polyester based formulation.

The present invention relates to a heat-cleaning process to remove mesh, adhesive, printing ink and/or residual paint from the frames. Optionally, the frames are then powder coated to prevent them from rusting and to provide a consistent/uniform profile to which mesh can be attached.

The mesh, adhesive and printing ink applicable to this invention are not critical to the success and are well known in the art. As long as these are primarily organic materials, if residue remains they can be converted to gaseous decomposition products. Any minority inorganic components remain as a dry ash which can easily be removed.

The mesh may be any manufactured from polyester or nylon yarns and typically those manufactured by the companies Saati and Sefar Inc.

The adhesive can be any of the proprietary adhesives normally used in the art. Examples include polyester urethane solvent based adhesives, e.g. Serifix manufactured by Sericol, or Cyanoacrylate solvent based adhesives or solvent-free UV curable adhesives. These materials degrade well below the melting point of the frame.

Typically the frames used in screen printing are steel or aluminium. Temperatures over 650° C. (1200° F.) are required to distort the steel frames and temperatures over 425° C. (800° F.) are required to distort aluminium frames. (Aluminium melts at 600 to 650° C. (1100 to 1200° F.)) The heat-cleaning process of the present invention thermally degrades the mesh, adhesive, printing ink and any old paint on the frames reducing them to a non-hazardous dry ash. The operator should ensure that dry ash dust meets the relevant EPA and solid waste disposal standards (e.g. in the USA those governed by the RCRA/SARA).

The higher the temperature the faster the organic contaminants are burned off the frame, but the upper temperature limit is determined by the stability of the frame material. Clearly, the frame must not be heated above the point at which the frame distorts (the ‘distortion point’) thereby rendering the treated frame unsuitable for use in subsequent screen printing processes. The upper temperature limit at which the frame distorts will vary depending on the metal from which the frame is constructed. For example, an aluminium frame must not be heated above 425° C. (800° F.). A person skilled in the art would be able to adjust the temperature, and duration, of the heating process depending on the frame material.

The duration of heating the frame to remove contaminants will vary depending on the temperature of the oven. This may be from 30 min at 650° C. (1200° F.) to 8 hours at 150° C. (300° F.). Typically, for a steel frame, heating would be for 2 hours or less at 370° C. (700° F.)

The present process may be performed repeatedly (50 times or more) without deteriorating the frame.

Any toxic fumes created in the process are converted by an after burner into clean, environmentally safe, odourless gases. The hot stack gases discharged to the atmosphere consist primarily of excess oxygen, nitrogen, water vapour and carbon dioxide. This assures compliance with the most stringent World Environmental Standards such as in the US EPA and regional air pollution standards, and in Europe, regulations governed by the European Environmental Protection Acts.

The frames are then preferably painted with a powder coat to prevent them from rusting and to provide the same consistent profile (via the powder coat) on all frames. By applying a powder coating, the mesh can be easily and consistently attached to every frame.

Powder coatings are known in the art, for example epoxy resin, such as Sherwin Williams Powdura Card i.e. Iron Gate #EBS2-C000 or Herberts O'Brien product Pac Black #EFB-408-S3 or polyester resin, such as Sherwin Williams Low Cure Black Polyester TGIG #01T-0152/PBS2, but may be any number of the commercially available powder coatings which give good adhesion to frame and glue to powder coat, and chemical resistance to the chemicals used in the screen printing process.

### EXAMPLE 1

Steps in the present process for heat-cleaning carbon steel frames are:

1) Place a batch of carbon steel frames containing polyester mesh and adhesive that are contaminated with printing ink into bake-off oven.

2) Increase the temperature of the bake-off oven to 370° C. (700° F.) in 30 minutes and then hold at 370° C. (700° F.) for approximately 90 minutes.

3) Remove the frames from the bake-off oven

4) Spray frames using a high pressure water spray to wash off any remaining ash material.

5) Spray frames using a high pressure iron phosphate or zinc phosphate solution to prepare the metal to receive powder coat.

6) Place the clean phosphated frame into powder coat booth.

7) Apply 1.5 to 2 ml of powder coat, i.e. “Hoberts O'Brien product Pac Black Epoxy, #EFB-408-S3”.

8) Place the powder coated frame in an oven and heat the surface temperature of the frame to 205° C. (400° F.) for approximately 10 minutes.

9) Test the cure of the powder coat using the standard ASTM # D3359-97 Test Method for Cross hatch Adhesion using M.E.K. rub.

### EXAMPLE 2

Steps in the present process for heat-cleaning aluminium frames are:

The same process was carried out as for Example 1 except with aluminium frames the temperature of the bake-off oven is ramped up to 315° C. (600° F.) in 30 minutes and then held at 315° C. (600° F.) for approximately 90 minutes. Polyester coating “Sherwin Williams Low Cure Black Polyester TGIG #01T-0152/PBS2” is used as the powder coating. The surface temperature of the powder coated frame is heated to 205° C. (400° F.) for approximately 10 minutes.

1. A process for regenerating used screen printing frames contaminated with residues from the screen printing process comprising heating the used frame at a sufficient temperature and for sufficient time to thermally degrade the residues.

2. A process as claimed in claim 1 wherein the residue is one or more of a mesh, an adhesive, a printing ink and residual paint.

3. A process as claimed in claim 1 or 2 wherein the heating is carried out at from 150° C. to below the distortion point of the frame.

4. A process as claimed in claim 3 wherein the frame consists substantially of aluminium and heating is carried out at 150 to 425° C.

5. A process as claimed in claim 3 wherein the frame consists substantially of steel and heating is carried out at 150 to 650° C.

6. A process as claimed in any preceding claim wherein the heating is carried out at 315 to 425° C.

7. A process as claimed in any preceding claim wherein the heating is carried out at 370° C.

8. A process as claimed in any preceding claim wherein the heating is carried out for 30 min to 8 hours.

9. A process as claimed in any preceding claim wherein the heating is carried out for 1 to 2 hours.

10. A process as claimed in any preceding claim wherein the heating is carried out until the residues are degraded to a dry ash.

11. A process as claimed in any preceding claim further comprising the application of a powder coating to the frame.

12. A process as claimed in claim 11 wherein the powder coating is an epoxy or polyester based formulation.
